(19) United States
(12) Patent Application Publication
(10) Pub. No.: US 2005/0130018 A1
(43) Pub. Date: Jun. 16, 2005

(54) Fuel cell diffusion layer

(76) Inventors: Zhiqiang Xu, Bloomfield, NJ (US); Zhigang Qi, North Arlington, NJ (US); Arthur Kaufman, West Orange, NJ (US)

Correspondence Address: FISH & RICHARDSON PC, 225 FRANKLIN ST, BOSTON, MA, 02110, US

(21) Appl. No.: 10/736,480

(22) Filed: Dec. 15, 2003

(51) Int. Cl. H01M 2/08; H01M 2/14

(52) U.S. Cl. 429/36; 429/38

(57) ABSTRACT

Fuel cell diffusion layers, and related systems and methods are disclosed.

### TECHNICAL FIELD

The invention relates to fuel cell diffusion layers, and related systems and methods.

### BACKGROUND

A fuel cell can convert chemical energy to electrical energy by promoting electrochemical reactions of two reactants.

One type of fuel cell includes a cathode flow field plate, an anode flow field plate, a membrane electrode assembly disposed between the cathode flow field plate and the anode flow field plate, and diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each reactant flow field plate has an inlet region, an outlet region and open-faced channels connecting the inlet region to the outlet region and providing a way for distributing the reactants to the membrane electrode assembly.

The membrane electrode assembly usually includes a solid electrolyte (e.g., a proton-exchange membrane) between a first catalyst and a second catalyst. One diffusion layer is between the first catalyst and the anode flow field plate, and another diffusion layer is between the second catalyst and the cathode flow field plate.

During operation of the fuel cell, one of the reactants (the anode reactant) enters the anode flow field plate at the inlet region of the anode flow field plate and flows through the channels of the anode flow field plate toward the outlet region of the anode flow field plate. The other reactant (the cathode reactant) enters the cathode flow field plate at the inlet region of the cathode flow field plate and flows through the channels of the cathode flow field plate toward the cathode flow field plate outlet region.

As the anode reactant flows through the channels of the anode flow field plate, some of the anode reactant passes through the anode diffusion layer and interacts with the anode catalyst. Similarly, as the cathode reactant flows through the channels of the cathode flow field plate, some of the cathode reactant passes through the cathode diffusion layer and interacts with the cathode catalyst.

The anode catalyst interacts with the anode reactant to catalyze the conversion of the anode reactant to reaction intermediates. The reaction intermediates include ions and electrons. The cathode catalyst interacts with the cathode reactant and the anode reaction intermediates to catalyze the conversion of the cathode reactant to the chemical product of the fuel cell reaction.

The chemical products of the fuel cell reaction flow through a diffusion layer to the channels of a flow field plate (e.g., the cathode flow field plate). The chemical products then flow along the channels of the flow field plate toward the outlet region of the flow field plate.

The electrolyte provides a barrier to the flow of electrons and reactants from one side of the membrane electrode assembly to the other side of the membrane electrode assembly. However, the electrolyte allows ionic reaction intermediates (e.g., protons) to flow from the anode side of the membrane electrode assembly to the cathode side of the membrane electrode assembly.

Therefore, the ionic reaction intermediates can flow from one side of the membrane electrode assembly to the other side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load and to the cathode flow field plate, and the cathode side of the membrane electrode assembly.

Because electrons are formed at the anode side of the membrane electrode assembly, the anode reactant undergoes oxidation during the fuel cell reaction. Because electrons are consumed at the cathode side of the membrane electrode assembly, the cathode reactant undergoes reduction during the fuel cell reaction.

For example, when methanol and molecular oxygen are the reactants used in a fuel cell (e.g., in a direct methanol fuel cell), the methanol flows through the anode flow field plate and undergoes oxidation. The molecular oxygen flows through the cathode flow field plate and undergoes reduction. The specific reactions that occur in the fuel cell are represented in equations 1-3.
CH₃OH+H₂O→CO₂+6H⁺+6e⁻ (1)
3/2O₂+6H⁺+6e⁻→3H₂O (2)
CH₃OH+3/2O₂→CO₂+2H₂O (3)

As shown in equation 1, methanol forms CO₂, protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with the molecular oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

In one aspect, the invention features an article that includes a fuel cell diffusion layer having a sulfonic acid moiety covalently bonded thereto. The sulfonic acid moiety has the formula RSO₃H, and R is [symbol] , an alkyl moiety, an alkenyl moiety, an alkynyl moiety, an aryl moiety, or a heteroaryl moiety.

In another aspect, the invention features a fuel cell that includes two fuel cell flow plates, an electrolyte between the fuel cell flow plates, and a fuel cell diffusion layer between the first fuel cell flow plate and the electrolyte. A sulfonic acid moiety is covalently bonded to the fuel cell diffusion layer. The sulfonic acid moiety has the formula RSO₃H, and R is [symbol] , an alkyl moiety, an alkenyl moiety, an alkynyl moiety, an aryl moiety, or a heteroaryl moiety.

In a further aspect, the invention features a method of making a fuel cell diffusion layer where a sulfonic acid precursor moiety is covalently bonded thereto. The sulfonic acid precursor has the formula RSO₂X, and R is [symbol] , an alkyl moiety, an alkenyl moiety, an alkynyl moiety, an aryl moiety, or a heteroaryl moiety, and X is a halogen.

In still a further aspect, the invention features an article that includes a fuel cell diffusion layer and an acidic moiety covalently bonded to the fuel cell diffusion layer. The acidic moiety has the formula R-A. R is [symbol] , an alkyl moiety, an alkenyl moiety, an alkynyl moiety, an aryl moiety, or a heteroaryl moiety. A can be, for example, SO₃H, PO₃H₂, AsO₃H₂ or COOH.

As used herein, the symbol “ [symbol] ” refers to a direct bond between the sulfur atom in the sulfonic acid moiety and the fuel cell diffusion layer.

As used herein, the term “alkyl moiety” refers to an unsaturated hydrocarbon chain that may be a straight chain or branched chain. In general, the number of carbon atoms in an alkyl moiety can be varied as desired (e.g., one to ten carbon atoms, one to six carbon atoms, one to three carbon atoms). An alkyl moiety can be substituted (e.g., substituted with one or more halogens) or unsubstituted.

As used herein, the term “halogen” refers to fluorine, chlorine, bromine or iodine.

As used herein, the term “alkenyl moiety” refers to a hydrocarbon chain having at least one carbon-carbon double bond. In general, the number of carbon atoms in an alkenyl moiety can be varied as desired (e.g., two to ten carbon atoms, two to six carbon atoms, two to three carbon atoms). An alkenyl moiety can be substituted (e.g., substituted with one or more halogens, substituted with one or more alkyl) or unsubstituted.

As used herein, the term “alkynyl moiety” refers to a hydrocarbon chain having at least one carbon-carbon triple bond. In general, the number of carbon atoms in an alkynyl moiety can be varied as desired (e.g., two to ten carbon atoms, two to six carbon atoms, two to three carbon atoms). An alkynyl moiety can be substituted (e.g., substituted with one or more halogens, substituted with one or more alkyl) or unsubstituted.

As used herein, the term “aryl moiety” refers to a carbon-containing moiety having at least one aromatic ring. For example, an aryl moiety can contain at least one 6-carbon monocyclic aromatic ring and/or at least one 10-carbon bicyclic aromatic ring system. The atoms in the ring of an aryl moiety can be substituted (e.g., substituted with one or more halogens, substituted with one or more alkyl) or unsubstituted.

As used herein, the term “heteroaryl moiety” refers to a carbon-containing moiety that has at least one aromatic ring with at least one non-carbon atom (e.g., O, S, N) in the ring. Examples of heteroaryls include: aromatic 5-8 membered monocyclic rings with at least one O, S and/or N in the ring; 8-12 membered bicyclic rings with at least one O, S and/or N in the ring; and 11-14 membered tricyclic rings with at least one O, S and/or N in the ring. Generally, for monocyclic ring systems, the number of non-carbon atoms in the ring is one, two or three; for bicyclic rings, the number of non-carbon atoms in the ring is one, two, three, four, five or six; for tricyclic rings, the number of non-carbon atoms in the ring is one, two, three, four, five, six, seven, eight or nine.

Embodiments can have one or more of the following features.

In some embodiments, R is [symbol] (i.e., the sulfonic acid moiety is directly bonded to the fuel cell diffusion layer).

In certain embodiments, R is an alkyl moiety that substituted with one or more halogens.

In some embodiments, R is an aryl moiety substituted with one or more halogens and/or alkyl moieties.

In certain embodiments, the fuel cell diffusion layer is formed of carbon (e.g., porous carbon or a carbon sheet).

In some embodiments, the fuel cell diffusion layer includes a microporous layer, where carbon particles are one of the components of the microporous layer.

In some embodiments, the fuel cell diffusion layer also includes a catalyst (e.g., a Pt catalyst). In some instances, the fuel cell diffusion layer includes from about one weight percent to about 50 weight percent of the catalyst.

In certain embodiments, the aqueous permeability of the article is greater than the aqueous permeability of the fuel cell diffusion layer.

In some embodiments, the article includes a proton conducting material (e.g., Nafion).

In certain embodiments, the article has an initial contact angle with water of less than about 125°.

In some embodiments, the article has an initial contact angle with water that is at least about 15% less than an initial contact angle of water with the diffusion layer.

In certain embodiment, the article has an initial contact angle with water that is at least about 20° less than an initial contact angle of water with the diffusion layer.

In some embodiments, the fuel cell is a proton-exchange membrane fuel cell. In certain embodiments, the fuel cell is a direct-feed liquid fuel cell (e.g., a direct alcohol fuel cell). Examples of direct alcohol fuel cells include direct methanol fuel cells and direct propanol fuel cells.

In certain embodiments, the sulfonic acid moiety is created by using chlorosulfonic acid or fuming sulfuric acid as the sulfonating agent.

In some embodiments, the sulfonating agent is diluted in an organic solvent or acetic acid.

In certain embodiments, the sulfonating agent is neat.

Embodiments can provide one or more of the following advantages.

In some embodiments, the fuel cell can exhibit enhanced performance. Without wishing to be bound by theory, it is believed that the polarity of the sulfonic acid moiety increases water permeability of the fuel cell diffusion layer, and that this can enhance transport of a fuel contained in water (e.g., methanol) to the catalyst layer. This can improve performance and/or increase the useful lifetime of the fuel cell.

In certain embodiments, protons from the sulfonic acid moieties are used to ion exchange with positively charged metal cations. The cations may then be converted to metal forms to function, for example, as catalysts.

### DESCRIPTION OF DRAWINGS

FIG. 1 is a cross-sectional view of an embodiment of a fuel cell.

FIG. 2 is an elevational view of an embodiment of an anode flow field plate.

FIG. 3 is an elevational view of an embodiment of a cathode flow field plate

FIG. 4 is an elevational view of an embodiment of a coolant flow field plate

FIG. 5a is a diagram of the location on a fuel cell diffusion layer where contact angle measurements were obtained.

FIG. 5b is a pictorial showing the contact angle θ of a water drop on a surface of a fuel cell diffusion layer.

FIGS. 6a and 6b are micrographs of an unsulfonated carbon paper taken using scanning electron microscopy.

FIGS. 6c and 6d are micrographs of a sulfonated carbon paper taken using scanning electron microscopy.

FIG. 7a is a plot of an energy dispersive X-ray emission analysis of an unsulfonated carbon paper.

FIG. 7b is a plot of an energy dispersive X-ray emission analysis of a sulfonated carbon paper.

### DETAILED DESCRIPTION

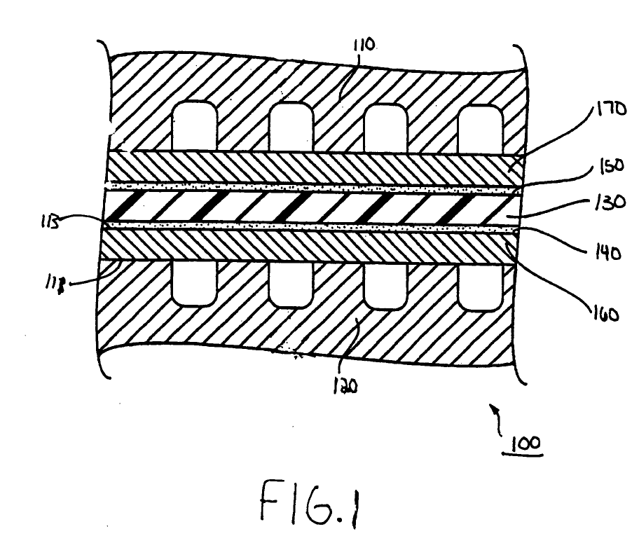

FIG. 1 shows a direct methanol fuel cell 100 that includes a cathode flow field plate 110, an anode flow field plate 120, a solid electrolyte 130, catalysts 140 and 150 and diffusion layers l60 and 170.

Typically, diffusion layers 160 and 170 are formed of a material that is both gas and liquid permeable, allowing reactants (e.g., methanol in water) and products to pass therethrough. Additionally, diffusion layers 160 and 170 are generally electrically conductive so that electrons can flow from catalysts 140 and 150 to flow field plates 120 and 110, respectively. Layers 160 and 170 can be further treated, for example, by infusing them with polytetrafluoroethylene (e.g., TEFLON®) to enhance hydrophobicity. In general, layers 160 and 170 are made from a layer of porous carbon (e.g., carbon paper or a carbon sheet).

Diffusion layer 160 has covalently bonded thereto sulfonic acid moieties (RSO₃H), where R is [symbol] , an alkyl moiety, an alkenyl moiety, an alkynyl moiety, aryl moiety, or a heteroaryl moiety. The sulfonic acid moiety can be bonded to a surface 111 of layer 160, a surface 113 of layer 160 and/or within pores present in layer 160.

In some embodiments, the sulfonic acid moiety can be directly covalently bonded to diffusion layer 160 (R is [symbol] ), forming C—SO₃H bonds with layer 160.

In certain embodiments, the sulfonic acid moiety can be indirectly covalently bonded to diffusion layer 160. In such embodiments, R represents a linker moiety that is present between diffusion layer 160 and the sulfur atom in the sulfonic acid moiety. In general, a linker moiety can be any moiety capable of covalently bonding —SO₃H to diffusion layer 160. In embodiments in which diffusion layer 160 is formed of carbon, the structure can be represented by C-linker-SO₃H. Examples of linker moieties include alkyl moieties (e.g., C₁-C₁₀ alkyl, C₁-C₆ alkyl, or C₁-C₃ alkyl); alkenyl moieties (e.g., C₂-C₁₀ alkenyl, C₂-C₆ alkenyl, C₂-C₃ alkenyl); alkynyl moieties (e.g., C₂-C₁₀ alkynyl, C₂-C₆ alkynyl, C₂-C₃ alkynyl); aryl moieties or heteroaryl moieties. In some instances, multiple linker moieties can be used with one more heteroatoms, such as, for example, O, N, S, P, or halogen (e.g., the linker can be alkyl-O-alkyl, alkyl-S-alkyl, etc.).

A sulfonic acid moiety can be covalently bonded to diffusion layer 160 in a variety of ways.

In some embodiments, a sulfonic acid moiety can be directly covalently bonded to diffusion layer 160 (e.g., carbon paper) by reacting one or more carbon atoms of layer 160 with chlorosulfonic acid as depicted in the reaction scheme below:
C—H+ClSO₃H→C—SO₃H+HCl

In some embodiments, carbon paper (e.g., Toray carbon paper) is immersed into a mixture of chlorosulfonic acid diluted in dichloromethane for a period of time (e.g., about 10 minutes). The carbon paper is then washed (e.g., with water) and dried.

The degree of sulfonation can generally be controlled by modifying appropriate reaction condition, such as, for example, the length of reaction time, reaction temperature, concentration of reagents, and solvent. As an example, if a higher degree of sulfonation is desired, the carbon paper can remain immersed in the solution of chlorosulfonic acid for a longer period of time (e.g., greater than about 10 minutes, greater than about 15 minutes, or greater than about 20 minutes), or the carbon paper can be immersed in a more concentrated solution of chlorosulfonic acid (e.g., neat chlorosulfonic acid). As another example, if a lower degree of sulfonation is desired, the carbon paper can be treated with a reduced reaction time or a diluted concentration of chlorosulfonic acid (e.g., the chlorosulfonic acid can be diluted in organic solvent, such as dichloromethane).

In certain embodiments, a different reagent can be used instead of or in addition to chlorosulfonic acid to covalently bond a sulfonic acid moiety to a carbon diffusion layer 160. For example, the diffusion layer 160 can be treated with sulfuric acid (e.g., fuming sulfonic acid), chloromethylsulfonic acid, or other chemical species that can react with diffusion layer 160 to provide a sulfonic acid moiety covalently bonded to diffusion layer 160.

In general, the presence of the sulfonic acid moiety increases the hydrophilicity of diffusion layer 160. As an example, in some embodiments, the initial contact angle of diffusion layer 160 with water after covalently bonding the sulfonic acid moiety is at least about 15% less (e.g., at least about 20% less, at least about 25% less) than the initial contact angle with water of diffusion layer 160 before covalently bonding the sulfonic acid moiety. As another example, the initial contact angle of diffusion layer 160 with water after covalently binding the sulfonic acid moiety is at least about 20° less (e.g., at least about 25° less, at least about 30° less) than the initial contact angle with water of diffusion layer 160 before covalently bonding the sulfonic acid moiety. The contact angle of the surface of an article with water is measured as described below.

In some embodiments, layer 160 has an initial contact angle with water that is less than about 125° (e.g., less than about 120°, less than about 115°, less than about 110°). The contact angle of the surface of an article with water is measured as described below.

In general, the presence of the sulfonic acid moiety increases the aqueous permeability of diffusion layer 160. For example, in some embodiments, the aqueous permeability of diffusion layer 160 after covalently bonding the sulfonic acid moiety is at least about 10% greater (e.g., at least about 15% greater, at least about 20% greater) than the aqueous permeability of diffusion layer 160 before covalently bonding the sulfonic acid moiety.

Typically, anode flow field plate 120 and cathode flow field plate 110 are formed of a carbon material (e.g., graphite, such as porous graphite or nonporous graphite).

Electrolyte 130 should be capable of allowing ions to flow therethrough while providing a substantial resistance to the flow of electrons. In some embodiments, electrolyte 130 is a solid polymer (e.g., a solid polymer ion exchange membrane), such as a solid polymer proton exchange membrane (e.g., a solid polymer containing sulfonic acid moieties). Such membranes are commercially available from E.I. DuPont de Nemours Company (Wilmington, Del.) under the trademark NAFION. Alternatively, electrolyte 130 can also be prepared from the commercial product GORE-SELECT, available from W.L. Gore & Associates (Elkton, Md.).

Catalyst 140 can be formed of a material capable of interacting with methanol to form CO₂, protons and electrons. Examples of such materials include, for example, platinum, platinum alloys, such as platinum-ruthenium, and platinum dispersed on carbon black. Catalyst 140 can further include an electrolyte, such as an ionomeric material, e.g., NAFION, that allows the anode to conduct protons. Alternatively, a suspension is applied to the surfaces of diffusion layers (described below) that face electrolyte 130, and the suspension is then dried. In some embodiments, a catalyst material (e.g., platinum) can be applied to electrolyte 130 using standard techniques. The method of preparing catalyst 140 may further include the use of pressure and temperature to achieve bonding.

Catalyst 150 can be formed of a material capable of interacting with oxygen, electrons and protons to form water. Examples of such materials include, for example, platinum, platinum alloys, and noble metals dispersed on carbon black. Catalyst 150 can further include an electrolyte, such as an ionomeric material, e.g., NAFION, that allows the cathode to conduct protons. Catalyst 150 can be prepared as described above with respect to catalyst 140.

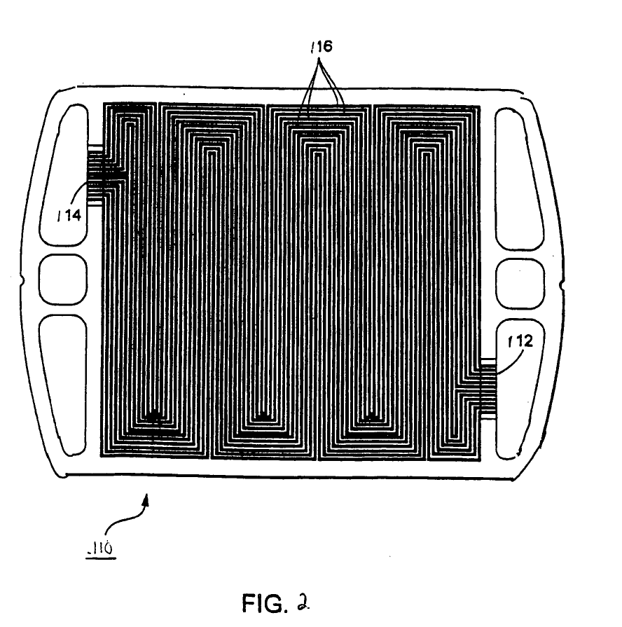

FIG. 2 shows an embodiment of cathode flow field plate 110, which is used to provide a flow path that allows the molecular oxygen to interact with catalyst 150 during use of fuel cell 100. Cathode flow field plate 110 has an inlet 112, an outlet 114 and open-faced channels 116 that define a flow path for an oxidant from inlet 112 to outlet 114. As the oxidant flows along channels 116, the molecular oxygen contained in the oxidant permeates diffusion layer 170 to interact with catalyst 150, electrons and protons to form water. The water can pass back through diffusion layer 170, enter the oxidant stream in channels 116, and exit fuel cell 100 via outlet 114.

FIG. 3 shows an embodiment of anode flow field plate 120, which is designed to provide a flow path for a fuel that allows the molecular hydrogen to interact with catalyst 140 during use of fuel cell 100. Anode flow field plate 120 has an inlet 222, outlet 224 and open-faced channels 226 that define a flow path for a fuel from inlet 222 to outlet 224. The protons pass through solid electrolyte 130, and the electrons are conducted through diffusion layer 160 to anode flow field plate 120, flowing through an external load to cathode flow field plate 110, then to diffusion layer 170, and ultimately catalyst layer 150. The unreacted fuel exits fuel cell 100 via outlet.

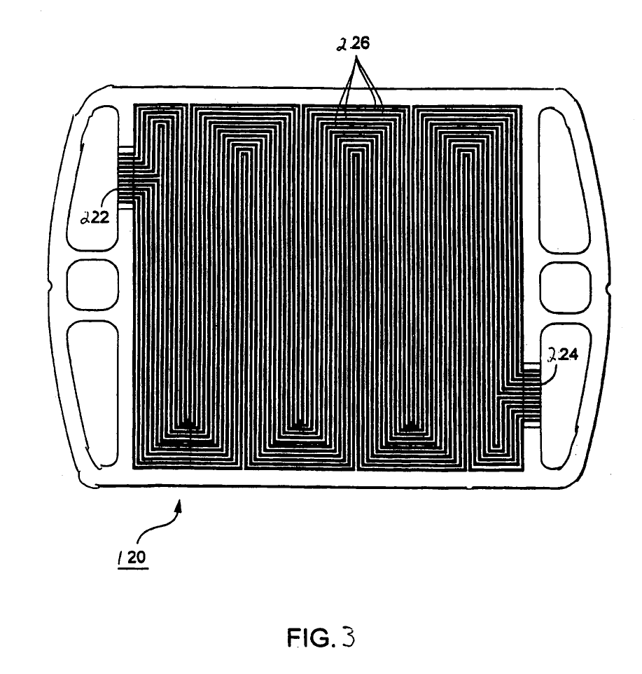

The heat produced during the fuel cell reaction can be removed by flowing a coolant through the fuel cell via a coolant flow field plate. FIG. 4 shows an embodiment of a coolant flow field plate 300 having an inlet 310, an outlet 320 and open-faced channels 330 that define a flow path for coolant from inlet 310 to outlet 320. The coolant enters fuel cell 100 via inlet 310, flows along channels 330 and absorbs heat, and exits fuel cell 100 via outlet 320.

The following examples are illustrative and not intended to be limiting.

### EXAMPLES

Toray paper (4.5 cm×6.2 cm) that had been telfonated by a mixture of Vulcan XC-72 and PTFE was sulfonated under the following conditions: 5 times dilution of chlorosulfonic acid by dichloromethane, 10-minute immersion of the paper into this diluted mixture at room temperature.

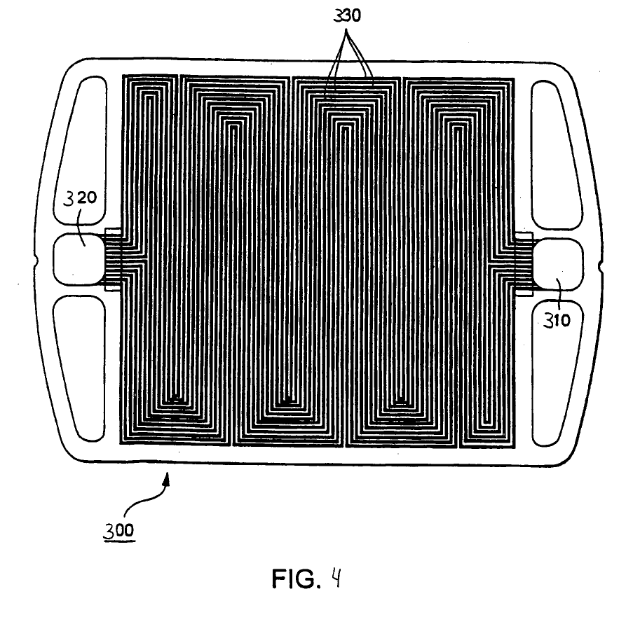

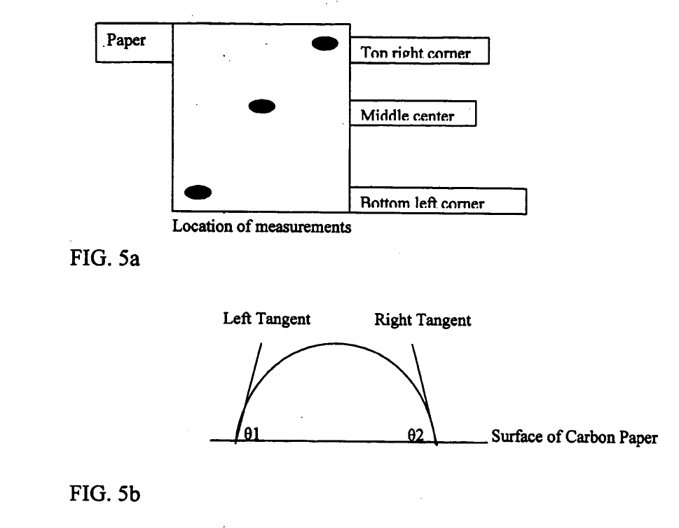

The contact angle measurement was performed using a Rame-Hart Goniometer model # 100-00 by following ASTM D724-99: standard test method for surface wettability of paper. The paper was measured using three water drops purposely applied onto the top right corner, middle center, and bottom left corner (See FIG. 5a). Each angle was an average of the left contact (θ1) and right contact (θ2) of the water drop with the carbon paper (See FIG. 5b).

Table 1 shows results averaged from the three different locations for paper before and after sulfonation at different times. Initial refers to a measurement that was taken less than one minute from the moment the water drop was laid onto the paper. Two subsequent measurements were taken at 5 and 15 minutes, respectively.

TABLE 1
Contact Angle of Water

Contact Angle (°)

| GDL Conditions | Initial | 5 minutes later | 15 minutes later |
|---|---|---|---|
| Unsulfonated | 145 | 140 | 130 |
| Sulfonated | 123 | 115 | 105 |

The initial contact angles were 145° and 123° for the unsulfonated paper and sulfonated paper, respectively, demonstrating that covalently bonding the sulfonic acid moiety increased the hydrophilicity of the paper. While the contact angles decreased with time for both sulfonated and unsulfonated papers, the decrease was greater for the sulfonated paper.

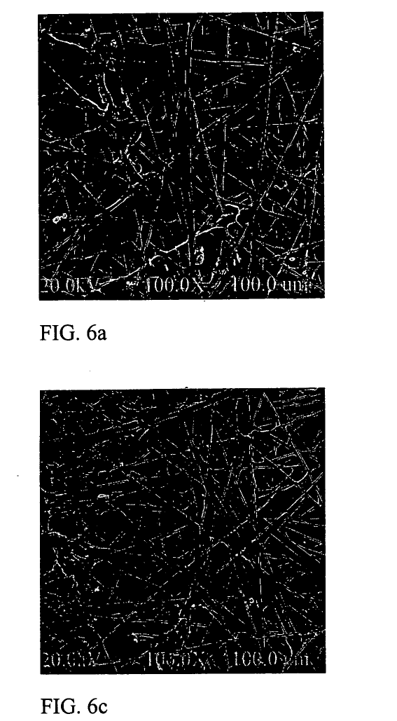

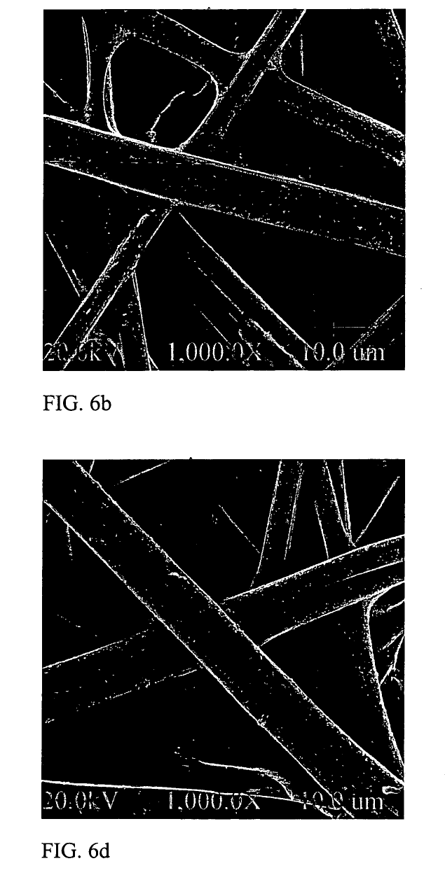

Scanning Electron Microscopy (SEM) was performed using JEOL 6400 SEM with an IXRF 500 EDS Digital Processor to examine if the surface morphology of the carbon paper was changed after sulfonation. Referring to FIGS. 6a-6d, no change was observed in surface morphology between the sulfonated and unsulfonated plate.

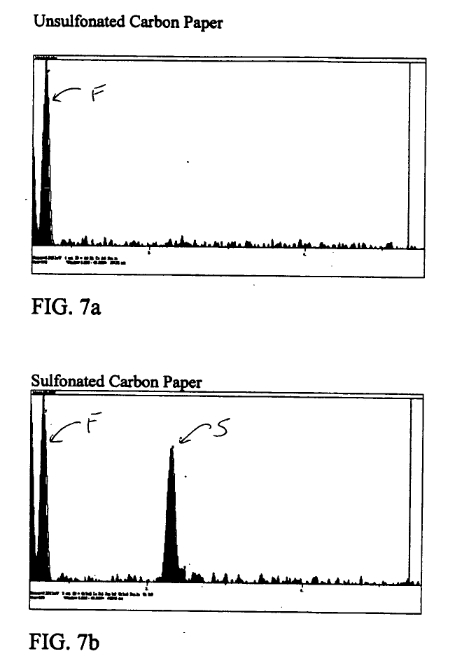

The linkage of —SO₃H onto carbon paper was confirmed by energy dispersive X-ray emission analysis. No S was detected in the unsulfonated carbon paper (See FIG. 7a). However, in the case of the sulfonated carbon paper, a significant amount of S was detected, as shown by the spectra shown in FIG. 7b and the data in Tables 2 and 3 below.

TABLE 2
EDS Analysis of Unsulfonated Carbon Paper

| | | Intensity | | |
|---|---|---|---|---|
| Elt. | Line | (counts/s) | Atomic % | |
| C | Ka | 361.32 | 96.017 | |
| F | Ka | 20.13 | 3.983 | |
| | | | 100.000 | Total |

TABLE 3
EDS Analysis of Sulfonated Carbon Paper

| | | Intensity | | |
|---|---|---|---|---|
| Elt. | Line | (counts/s) | Atomic % | |
| C | Ka | 428.60 | 96.373 | |
| F | Ka | 22.10 | 3.306 | |
| S | Ka | 25.06 | 0.321 | |
| | | | 100.000 | Total |

While certain embodiments have been described, other embodiments are possible.

As an example, while embodiments have been described in which a diffusion layer and a catalyst layer are separate layers, in some embodiments, the catalyst material (e.g., a platinum catalyst) can be incorporated into layer 160 and/or layer 170. In embodiments in which a catalyst is incorporated in a diffusion layer, the diffusion layer can include, for example, at least about one weight percent (e.g., at least about five weight percent, at least about 10 weight percent, at least about 12 weight percent, at least about 14 weight percent, at least about 16 weight percent, at least about 18 weight percent, at least about 20 weight percent) catalyst and/or at most about 50 weight percent (e.g., at most about 40 weight percent, at most about 30 weight percent, at most about 28 weight percent, at most about 26 weight percent, at most about 24 percent weight percent, at most about 22 weight percent) catalyst.

As another example, while embodiments have been described for a direct methanol fuel cell, other types of direct-feed liquid fuel cells can also be used. In some embodiments, a different type of direct alcohol fuel cell (direct ethanol fuel cell, direct propanol fuel cell) can be used. Further, in certain embodiments, a fuel cell other than a direct-feed liquid fuel cell (e.g., a proton-exchange membrane fuel cell, a solid oxide fuel cell) can be used.

As a further example, while diffusion layers have been described of being formed of carbon materials, other materials can also be used.

As another example, while embodiments of an anode diffusion layer having a sulfonic acid moiety bonded thereto have been described, in certain embodiments, a cathode diffusion layer can have a sulfonic acidic moiety bonded thereto. In certain embodiments, both the anode and cathode diffusion layers have a sulfonic acid moiety bonded thereto.

In some embodiments, the acidic moiety has the formula R-A, where R is as described above, and A is an acidic moiety. Examples of such acidic moieties include SO₃H, PO₃H₂, AsO₃H₂ and COOH.

The fuel cells can be used in a variety of applications, including, for example, in automobiles or stationary systems (e.g., systems designed to power a home).

Other embodiments are in the claims.

1. An article, comprising:
a fuel cell diffusion layer; and
a sulfonic acid moiety covalently bonded to the fuel cell diffusion layer,
wherein the sulfonic acid moiety has the formula RSO₃H, and R is [symbol] , an alkyl moiety, an alkenyl moiety, an alkynyl moiety, an aryl moiety, or a heteroaryl moiety.

2. The article of claim 1, wherein R is [symbol] .

3. The article of claim 1, wherein R is alkyl substituted with halogen.

4. The article of claim 1, wherein R is aryl substituted with halogen, or an alkyl moiety.

5. The article of claim 1, wherein the fuel cell diffusion layer comprises carbon.

6. The article of claim 5, wherein the fuel cell diffusion layer is in the form of a sheet.

7. The article of claim 1, wherein the fuel cell diffusion layer further comprises a catalyst.

8. The article of claim 7, wherein the catalyst is Pt.

9. The article of claim 7, wherein the fuel cell diffusion layer comprises from about one weight percent to about 50 weight percent of the catalyst.

10. The article of claim 1, wherein an aqueous permeability of the article is greater than the aqueous permeability of the fuel cell diffusion layer.

11. The article of claim 1, wherein the article comprises a proton conducting material.

12. The article of claim 11, wherein the proton conducting material comprises perfluorinated sulfonic acid.

13. The article of claim 1, wherein the article has an initial contact angle with water of less than about 125°.

14. The article of claim 1, wherein the article has an initial contact angle with water that is at least about 15% less than an initial contact angle of water with the diffusion layer.

15. The article of claim 1, wherein the article has an initial contact angle with water that is at least about 30% less than an initial contact angle of water with the diffusion layer.

16. The article of claim 1, wherein the article has an initial contact angle with water that is at least about 40% less than an initial contact angle of water with the diffusion layer.

17. The article of claim 1, wherein the article has an initial contact angle with water that is at least about 20° less than an initial contact angle of water with the diffusion layer.

18. A fuel cell, comprising:
a first fuel cell flow plate;
a second fuel cell flow plate;
an electrolyte between the first and second fuel cell flow plates;
a diffusion layer between the first fuel cell flow plate and the electrolyte; and
a sulfonic acid moiety covalently bonded to the diffusion layer,
wherein the sulfonic acid moiety has the formula RSO₃H, and R is [symbol] , an alkyl moiety, an alkenyl moiety, an alkynyl moiety, an aryl moiety, or a heteroaryl moiety.

19. The fuel cell system of claim 18, wherein the fuel cell is a proton-exchange membrane fuel cell.

20. The fuel cell system of claim 18, wherein the fuel cell is a direct-feed liquid fuel cell.

21. The fuel cell system of claim 18, wherein the fuel cell is a direct alcohol fuel cell.

22. The fuel cell system of claim 18, wherein the fuel cell system is a direct methanol fuel cell system.

23. The fuel cell system of claim 18, wherein the fuel cell system is a direct propanol fuel cell system.

24. A method of making a fuel cell diffusion layer, the method comprising:
covalently bonding a sulfonic acid moiety to the fuel cell diffusion layer, wherein, the sulfonic acid moiety has the formula RSO₂X, and R is [symbol] , an alkyl moiety, an alkenyl moiety, an alkynyl moiety, an aryl moiety, or a heteroaryl moiety, and X is a halogen.

25. The method of claim 24, wherein the sulfonic acid precursor moiety is formed from chlorosulfonic acid.

26. The method of claim 24, wherein the sulfonic acid precursor moiety is formed from fuming sulfuric acid.

27. The method of claim 24, wherein the sulfonic acid precursor moiety is formed from a sulfonating agent diluted in an organic solvent.

28. The method of claim 24, wherein the sulfonic acid precursor moiety is formed from a sulfonating agent diluted in acetic acid.

29. The method of claim 24, wherein the sulfonic acid precursor moiety is formed from a sulfonating agent that is neat.

30. The method of claim 24, wherein the carbon particles are in the form of a sheet.

31. The method of claim 30, wherein the sheet is a fuel cell diffusion layer.

32. The method of claim 24, wherein the diffusion layer also includes a microporous layer.

33. An article, comprising:
a fuel cell diffusion layer; and
an acidic moiety covalently bonded to the fuel cell diffusion layer, wherein:
the acidic moiety has the formula R-A;
R is [symbol] , an alkyl moiety, an alkenyl moiety, an alkynyl moiety, an aryl moiety, or a heteroaryl moiety; and
A is selected from the group consisting of SO₃H, PO₃H₂, AsO₃H₂, and COOH.
